(19) United States
(12) Patent Application Publication
(10) Pub. No.: US 2019/0381610 A1
(43) Pub. Date: Dec. 19, 2019

(54) METHOD FOR ESTABLISHING AN INTEGRALLY BONDED CONNECTION

(71) Applicants: THYSSENKRUPP STEEL EUROPE AG, DUISBURG (DE); THYSSENKRUPP AG, ESSEN (DE)

(72) Inventors: DAVID PIERONEK, DORTMUND (DE); STEFAN MYSLOWICKI, MÖNCHENGLADBACH (DE); MARCO QUELLER, VOERDE (DE)

(21) Appl. No.: 16/483,242

(22) PCT Filed: Jan. 31, 2018
(86) PCT No.: PCT/EP2018/052366

§ 371 Date: Sep. 3, 2019

(30) Foreign Application Priority Data
Feb. 2, 2017 (DE) 10 2017 201 697.3

(51) Int. Cl. B23K 31/02; B32B 15/01

(52) U.S. Cl. CPC B23K 31/02; B23K 2101/18; B32B 15/011

(57) ABSTRACT

The invention relates to a method for producing a substance-to-substance bond (3) between a first semifinished product (1) and a second semifinished product (2).

### TECHNICAL FIELD

The invention relates to a method for producing a substance-to-substance bond between a first semifinished product and a second semifinished product.

### TECHNICAL BACKGROUND

A search is on within the automobile industry for new solutions in order to reduce fuel consumption. Lightweight construction is an essential building block in this search, to enable the weight of the vehicle to be lowered. It can be achieved by measures including the use of materials of enhanced strength. The strength enhancement is generally accompanied by a reduction in bendability. In order to ensure the occupant protection that is also required in the case of crash-relevant components for the implementation of lightweight construction in spite of enhanced strength, it is necessary to ensure that the materials used are able to convert the energy introduced as a result of a crash, by deformation. This implies a high degree of forming capacity, particularly in a crash-relevant components of a vehicle structure. One way of saving weight is to design and build the bodywork, frame and/or chassis, for example, of a vehicle in even lighter form, by means of lightweight and innovative materials in comparison to the materials conventionally employed. For example, conventional materials may be replaced, in a specific manner for each component, by more lightweight materials having comparable properties. Finding their way more and more into the automobile industry, for example, are hybrid materials or materials composites that are composed of two or more different materials, with each individual material comprising particular properties, but the composite uniting essentially antithetical properties, in order to provide improved properties in the materials composite by comparison with the individual, monolithic materials. Materials composites, especially those made of various steel alloys, are known in the prior art—see, for example DE 10 2008 022 709 A1 and DE 10 2015 114 989 B3.

Advantageous properties are possessed in particular by steel alloys having a structure which comprises a certain austenite fraction, examples being steel alloys of high manganese content with high (tensile) strengths (Rₘ) and high elongations (at break) (A₈₀), thereby enabling the production, for example, of components with complex geometry or components for crash-relevant areas for absorbing the energy in the event of a crash. Steel alloys of these kinds are known from WO 2006/048034 A1, for example, and, for properties that remain the same, can be made thinner than conventional steel alloys, with the reduction in the thickness of material allowing a positive influence to be exerted on the overall weight of the component or of the vehicle. Such steel alloys are therefore outstandingly suitable for the automobile industry.

However, the chemical and physical properties of steel alloys having a defined austenite fraction in the structure, especially of steel alloys with high manganese content, are of limited coatability, especially with a zinc-based anticorrosion coat. An example for the coating of steel alloys of high manganese content is known from DE 10 2009 018 577 B3. For example, steel alloys of high manganese content which have been hot dip coated on the basis of zinc may tend toward hydrogen-induced cracking after shaping. Furthermore, steel alloys having a defined austenite fraction in the structure are also limited in their capacity to be assembled thermally, and especially soldered, since they lead to severe solder cracking and to soldered bonds that are unallowable according to DVS [German welding society] pamphlet 0938-2, as has been shown by studies as part of the AiF research project No. 15.201 B/DVS No. 1.058. Soldering is understood as a thermal method for the substance-to-substance bonding of materials with the aid of a material (solder) which has a low melting point, especially in comparison to the materials being bonded; with a liquid phase being formed under heating, by melting of a solder—also called melt soldering—or by diffusion of a solder at the interfaces—also called diffusion soldering—and, after the cooling of the liquid phase, the formation of a substance-to-substance join between the bonded materials is realized.

### SUMMARY OF THE INVENTION

It is an object of the present invention to specify a method for producing a substance-to-substance bond.

This object is achieved by means of a method having the features of claim 1.

In accordance with the invention the invention relates to a method for producing a substance-to-substance bond between a first semifinished product, comprising at least one first layer of a steel alloy having a structure which comprises an austenite fraction of at least 15 vol %, and at least one second layer made of a soft steel alloy, which is substance-to-substance bonded on one or both sides over the full area to the first layer, especially after shaping, as part or component, with at least one second semifinished product, in particular as part or component, made of a steel alloy, more particularly a monolithic steel alloy, wherein by means of a soldering process the second semifinished product is bonded to the second layer of the first semifinished product. Because the second layer of the first semifinished product is particularly suitable for soldering, and the second semifinished product consists preferably of a readily solderable steel alloy, such as of a microalloyed steel alloy, it is possible to generate an operationally reliable and stable soldered bond between the two semifinished products or parts or components.

The inventors have determined that by providing at least one second layer made of a soft steel alloy, which is substance-to-substance bonded on one or both sides over the full area to the first layer made of a steel alloy with a structure which comprises an austenite fraction of at least 15 vol %, more particularly at least 20 vol %, preferably at least 25 vol %, more preferably at least 30 vol %, it is possible to ensure that on at least one side, preferably both sides, there is no possibility of direct or unmediated contact with the first layer, meaning that the second layer, made of a soft steel alloy, acts as a functional coat. In the sense of the invention, soft steel alloys comprise (tensile) strengths of not more than 580 MPa, more particularly not more than 500 MPa, preferably not more than 450 MPa, more preferably not more than 400 MPa. The second layer or the soft steel alloy comprises properties which are particularly beneficial to thermal soldering. The first semifinished product can therefore be integrated into existing, standard operations without having to undertake any changes in the operating chain. Suitability for soldering is determined authoritatively by the properties on the surface of the semifinished product that are provided by virtue of the second layer as a functional coat. The steel alloy having an austenite content of at least 15 vol %, more particularly at least 20 vol %, preferably at least 25 vol %, more preferably at least 30 vol %, is not confined to carbon steel alloys; noncorroding steel alloys are also conceivable, especially Cr—Ni steel alloys.

According to a first configuration of the method, the first layer consists preferably of a manganese-containing steel alloy, more particularly of a TRIP, TWIP or FeMn steel alloy.

Manganese is an austenite-forming and austenite-stabilizing component and, particularly at a level of at least 2 wt %, has a positive influence on the strength. At high levels it leads to the formation of hardening structures (α′- and ε-martensite) and also to TRIP-capable and/or TWIP-capable austenite, and to particularly good strength/formability relationships. Above 35.0 wt %, for example, these mechanisms of induced plasticity are reduced, and further cost-relevant alloying serves no purpose. Manganese may be alloyed in particular up to a maximum of 30.0 wt % and, for example, with at least 6.0 wt %, more particularly with at least 10.0 wt %. The first layer may alternatively also consist of a Q&P steel alloy (quenching/partitioning) having a residual austenite fraction of at least 15 vol % in the structure. The second layer, for forming the single-sided or double-sided functional coat on the first layer, consists preferably of a microalloyed steel alloy, IF steel alloy or deep-drawing steel alloy, which can be soldered easily and conventionally without cost or complexity.

According to a further configuration of the method, the second layer, made of the soft steel alloy, comprises a thickness of material of between 0.2% and 15%, more particularly of between 0.5% and 10%, based on the total thickness of material of the semifinished product. The soft steel alloy envisaged as functional coat ought in terms of thickness of material to be made such that on the one hand the positive properties of the first layer undergo no substantial adverse influence, the thickness of material of the second layer (per side) being not more than 15%, more particularly not more than 10%, preferably not more than 7%, based on the total thickness of material of the semifinished product, and on the other hand to ensure that the first layer is not adversely influenced, in particular, by diffusion events resulting from a substance-to-substance assembly bond, with the thickness of material of the second layer (per side) being at least 0.2%, more particularly at least 0.5%, preferably at least 1%, based on the total thickness of material of the semifinished product.

According to a further configuration of the method, in the simplest embodiment, only one first layer is provided, with a single-side of the bonded second layer. The free surface of the second layer is preferably coated with a zinc-based anticorrosion coat. The semifinished product preferably comprises two second layers, which are disposed on both sides of the first layer and are substance-to-substance bonded to it over the full area, hence allowing a sandwich material to be provided which, according to application, may comprise a symmetrical or asymmetrical construction. Both free surfaces of the second layers may have been coated with an anticorrosion coat, based preferably on zinc.

According to a further configuration of the method, the semifinished product has been produced by cladding, especially roll cladding, or by casting. The first semifinished product has preferably been produced by hot roll cladding, as disclosed in German patent specification DE 10 2005 006 606 B3, for example. Reference is made to this patent specification, the content of which is hereby incorporated into the present application. Alternatively, the first semifinished product can be produced by casting, in which case one way of producing it is disclosed in Japanese laid-open specification JP-A 03 133 630. Metallic composite production is generally prior art.

The first semifinished product, especially after shaping to form a part or component, is used for a load-bearing construction. Load-bearing construction embraces frames and auxiliary frames, for example, in vehicle construction (passenger vehicle, utility vehicle, or trailer) or railroad construction, marine construction, or aerospace, but also in the building sector, examples being pillars.

### BRIEF DESCRIPTION OF THE DRAWING

In the text below, the invention is elucidated in more detail with a drawing showing an exemplary embodiment. In the drawing

FIG. 1) shows a diagrammatic sectional representation through a substance-to-substance bond between a first semifinished product and a second semifinished product.

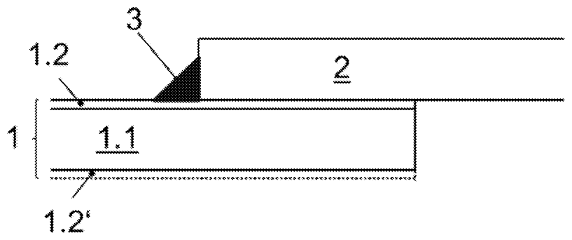

### DESCRIPTION OF THE PREFERRED EMBODIMENT

In the single FIGURE there is a diagrammatic sectional representation through a substance-to-substance bond (3) between a first semifinished product (1), or part or component, and a second semifinished product (2), or part or component, the bond taking the form of a fillet weld and having been produced by a soldering process. The semifinished product (1) comprises a first layer (1.1) made of a steel alloy having a structure which comprises an austenite fraction of at least 15 vol %, more particularly at least 20 vol %, preferably at least 25 vol %, more preferably at least 30 vol %, and consists in particular of a manganese-containing steel alloy, of the TWIP or TRIP type, for example, more preferably having a manganese content of between 10 and 30 wt %, and at least one second layer (1.2) made of a soft steel alloy, which is substance-to-substance bonded to the first layer (1.1) on one side and over the full area. The first layer may alternatively also consist of a Q&P steel alloy having a residual austenite fraction of at least 15 vol %. Shown as a line of dashes is a further second layer (1.2′), and this layer and the second layer (1.2) accommodate the first layer (1.1) between them, over the full area and in a substance-to-substance manner. The second layer (1.2, 1.2′), made of a soft steel alloy, comprises a strength of not more than 500 MPa, and in particular may consist of a microalloyed steel alloy, of type HX340LAD, for example. The thickness of material of the second layer (1.2, 1.2′) is in particular such, per side, that the positive properties of the first layer (1.1) are substantially not adversely influenced, with the thickness of material of the second layer (per side) being at least 0.2% and not more than 15%, based on the total thickness of material of the semifinished product (1), and the semifinished product (1) may comprise, for example, a total thickness of material of 0.5 and 4 mm. Since the second layer (1.2, 1.2′) of the semifinished product is suitable for coating and for soldering, the free surface of the second layer (1.2) bears a zinc-based anticorrosion coat. By way of the second layer (1.2), the semifinished product (1) is bonded to the second semifinished product (2) via a soldered fillet weld (3). The zinc-based anticorrosion coat may contribute to better wetting and/or to a better wetting angle of the soldered bond.

The invention is not confined to the exemplary embodiment shown in the drawing or else to the embodiments in the general description; instead, the first semifinished product may also be formed of a tailored product, such as a tailored blank and/or tailored rolled blank, for example. The second semifinished product as well, which is joined thermally to the first semifinished product by means of a soldering process, may also be designed as a materials composite, corresponding in particular to the first semifinished product, and may be designed cumulatively or alternatively as a tailored product.

1. A method for producing a substance-to-substance bond between a first semifinished product and a second semifinished product, comprising:
providing a first semifinished product comprising:
a first layer made of a steel alloy having a structure which comprises an austenite fraction of at least 15 vol %; and
at least one second layer consisting of a soft steel alloy having a tensile strength of not more than 580 MPa, as part or component;
wherein the at least one second layer is substance-to-substance bonded on one side over the full area to the first layer;
providing a second semifinished product as part or component, made of a steel alloy;
bonding the second semifinished product to the second layer of the first semifinished product by means of a soldering process.

2. The method as claimed in claim 1, characterized in that the first layer consists of a manganese-containing steel alloy and the second layer consists of a microalloyed steel alloy of an IF steel alloy or of a deep-drawing steel alloy.

3. The method as claimed in claim 1, characterized in that the second layer comprises a thickness of material of between 0.2% and 15%, based on the total thickness of material of the semifinished product.

4. The method as claimed in claim 1, characterized in that the semifinished product comprises two second layers, one of the second layers being disposed on one side of the first layer and the other of the second layers being disposed on an opposing side of the first layer; wherein the respective second layers are substance-to-substance bonded to 4 the respective side of the first layer over the full area.

5. The method as claimed in claim 1, characterized in that the semifinished product is produced by cladding or by casting.

6. The method as claimed in claim 2, characterized in that the first layer consists of a TRIP, TWIP or FeMn steel alloy.

7. The method as claimed in claim 3, characterized in that the second layer comprises a thickness of material of between 0.5% and 10%, based on the total thickness of material of the semifinished product.

8. The method as claimed in claim 2, characterized in that the second layer comprises a thickness of material of between 0.2% and 15%, based on the total thickness of material of the semifinished product.

9. The method as claimed in claim 8, characterized in that the second layer comprises a thickness of material of between 0.5% and 10%, based on the total thickness of material of the semifinished product.

10. The method as claimed in claim 2, characterized in that the semifinished product comprises two second layers, one of the second layers being disposed on one side of the first layer and the other of the second layers being disposed on an opposing side of the first layer; wherein the respective second layers are substance-to-substance bonded to the respective side of the first layer over the full area.

11. The method as claimed in claim 3, characterized in that the semifinished product comprises two second layers, one of the second layers being disposed on one side of the first layer and the other of the second layers being disposed on an opposing side of the first layer; wherein the respective second layers are substance-to-substance bonded to the respective side of the first layer over the full area.

12. The method as claimed in claim 7, characterized in that the semifinished product comprises two second layers, one of the second layers being disposed on one side of the first layer and the other of the second layers being disposed on an opposing side of the first layer; wherein the respective second layers are substance-to-substance bonded to the respective side of the first layer over the full area.

13. The method as claimed in claim 9, characterized in that the semifinished product comprises two second layers, one of the second layers being disposed on one side of the first layer and the other of the second layers being disposed on an opposing side of the first layer; wherein the respective second layers are substance-to-substance bonded to the respective side of the first layer over the full area.

14. The method as claimed in claim 2, characterized in that the semifinished product is produced by cladding or by casting.

15. The method as claimed in claim 3, characterized in that the semifinished product is produced by cladding or by casting.

16. The method as claimed in claim 4, characterized in that the semifinished product is produced by cladding or by casting.

17. The method as claimed in claim 6, characterized in that the semifinished product is produced by cladding or by casting.

18. The method as claimed in claim 7, characterized in that the semifinished product is produced by cladding or by casting.

19. The method as claimed in claim 1, characterized in that the semifinished product is produced by cladding or by casting.

20. The method as claimed in claim 11, characterized in that the semifinished product is produced by cladding or by casting.
